(19) United States
(12) Patent Application Publication
(10) Pub. No.: US 2014/0282426 A1
(43) Pub. Date: Sep. 18, 2014

(54) DIVIDE AND CONQUER APPROACH TO SCENARIO TIMELINE ACTIVITY ATTRIBUTION

(71) Applicant: MICROSOFT CORPORATION, Redmond, WA (US)

(72) Inventors: Alexander Kirshenbaum, Redmond, WA (US); Aaron Dietrich, Kirkland, WA (US); Mark Aldham, Seattle, WA (US); Jason Cohen, Woodinville, WA (US)

(73) Assignee: MICROSOFT CORPORATION, Redmond, WA (US)

(21) Appl. No.: 13/797,007

(22) Filed: Mar. 12, 2013

(51) Int. Cl. G06F 9/44

(52) U.S. Cl. CPC G06F 8/70
USPC 717/128

(57) ABSTRACT

In one embodiment, a system analyzer may iteratively sub-partition the trace timeline 202 of a computer system activity to more accurately understand the root causes 214 of various scenarios 204 in the trace timeline 202. The system analyzer may automatically partition a scenario 204 of the trace timeline 202 on a scenario-aware basis. The system analyzer may automatically sub-partition the scenario 204 into a sub-scenario set of the scenario 204. The system analyzer may display a sub-partitioned trace timeline 202 to a user.

### BACKGROUND

A software application may be tested by a developer before being released to the public, or even after release. A developer or other software operator may execute the software application to determine the operation of the software application. The developer or other software operator may record a trace timeline, registering the state of a computer system at each point during the execution of the software application. The trace timeline may provide a great deal of data for the developer or other software operator.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to iteratively sub-partitioning a trace timeline of a computer system activity to more accurately understand the root causes of various scenarios in the trace timeline. The system analyzer may automatically partition a scenario of the trace timeline on a scenario-aware basis. The system analyzer may automatically sub-partition the scenario into a sub-scenario set of the scenario. The system analyzer may display a sub-partitioned trace timeline to a user.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a computing device.

FIG. 2 illustrates, in a block diagram, one embodiment of a scenario tree.

FIG. 3 illustrates, in a block diagram, one embodiment of a partitioned trace timeline display.

FIG. 4 illustrates, in a flowchart, one embodiment of a method for creating a trace timeline.

FIG. 5 illustrates, in a flowchart, one embodiment of a method for sub-partitioning the trace timeline.

FIG. 6 illustrates, in a flowchart, one embodiment of a method for displaying a sub-partitioned trace timeline.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a system analyzer for a computing device.

A computer system activity may have a number of complex system and component activities making analysis difficult. Viewed holistically, this complexity may be reduced by dividing a timeline of the computer system activity into one or more scenarios, and further dividing the scenarios into sub-scenarios. A scenario is a state or event of the computer system activity. For example, a scenario may be that a computer device is in a “connected standby” state or an “active” state. A sub-scenario is a state or event that is a cause or facet of the scenario. In the above example, the scenario of the computer device being in the “active” state may be caused by a sub-scenario of a driver being in the wrong state or an activator holding a reference. These sub-scenarios may be further reduced to very basic activities, such as storage or network input/output. When partitioning the scenario down into individual sub-scenarios, the relationships between these sub-scenarios may be maintained, to accurately attribute the impact of these sub-scenarios to their parent scenarios.

For example, ten “file open” sub-scenarios during a user scenario may be neither conclusive of, nor fully describe, important attributes of that scenario. Nine out of these ten “file open” operations may be performed for completely unrelated reasons.

A divide-and-conquer approach to scenario timeline attribution may produce a more efficient activity analysis. This approach may enable better scenario understanding, known sub-scenario and activity attribution, and interactive expandable visualization. A system analyzer that iteratively partitions a trace timeline of a computer system activity may easily visualize the activity, mine the trace timeline for behaviors of interest, and analyze behaviors for root causes. The system analyzer may partition a trace timeline into one or more scenarios, and then sub-partition one or more of the scenarios into a set of sub-scenarios. The system analyzer may analyze each scenario or sub-scenario using sub-components specialized to each type of scenario or sub-scenario.

Understanding and representing scenario timelines may have potentially hundreds of events taking place simultaneously. These sub-scenarios may represent logical levels of the user scenario, which may be iteratively partitioned into additional sub-scenarios until basic activities are reached.

The system analyzer may account for each moment of a given scenario and attribute that moment to known sub-scenarios or activities. The system analyzer may partition the main scenario into sub-scenarios while keeping track of the activity dependency hierarchy until a basic activity is reached. A basic activity refers to either a smallest unit of detectable relevant behavior, such as a “storage read” request, or an irreducible sub-scenario.

The partitioning may occur “top down”, so that the scenario is first partitioned down into known sub-scenarios, which in turn get iteratively partitioned further, until the lowest possible level of known sub-scenarios or activities is reached. During this partitioning, for every set of sub-scenarios and activities occurring on the system, one or more subsets may be iteratively partitioned. The system analyzer may select the subset based on the knowledge of the scenario provided in the test criterion. The system analyzer may be aware of sub-scenarios and activities relevant to the main scenario and their inter-dependencies. The more scenario-specific knowledge the system analyzer may use, the more specific the scenario and activity attribution performed.

For example in a connected standby scenario timeline, a system may come out of the power-saving connected standby state. The system analyzer may be aware of each reason the system may not be in connected standby. The system analyzer may partition a time region into sub-regions, attributing each sub-region into one or more specific causes for not being in the lowest power state.

The system analyzer may use a scenario specific sub-component to examine a time region representing the scenario looking for known sub-scenarios and activities that may be affecting a scenario. The system analyzer may then further partition the time regions into different sub-regions representing different sub-scenarios that cause the main scenario. Some sub-scenarios may overlap at the same logic level of partitioning. Additionally, some sub-scenarios may overlap across logic levels of partitioning. The system analyzer may prioritize these sub-scenarios, with higher priority sub-scenarios shown to a user. Matching sub-scenarios may be aggregated at the presentation stage.

Thus, in one embodiment, a system analyzer may iteratively sub-partition a trace timeline of a computer system activity to more accurately understand the root causes of various scenarios in the trace timeline. The system analyzer may automatically partition a scenario of the trace timeline on a scenario-aware basis. The system analyzer may automatically sub-partition the scenario into a sub-scenario set of the scenario. The system analyzer may display a sub-partitioned trace timeline to a user.

FIG. 1 illustrates a block diagram of an exemplary computing device 100 which may act as a system analyzer. The computing device 100 may combine one or more of hardware, software, firmware, and system-on-a-chip technology to implement a system analyzer. The computing device 100 may include a bus 110, a processor 120, a memory 130, a data storage 140, an input device 150, an output device 160, and a communication interface 170. The bus 110, or other component interconnection, may permit communication among the components of the computing device 100.

The processor 120 may include at least one conventional processor or microprocessor that interprets and executes a set of instructions. The memory 130 may be a random access memory (RAM) or another type of dynamic data storage that stores information and instructions for execution by the processor 120. The memory 130 may also store temporary variables or other intermediate information used during execution of instructions by the processor 120. The data storage 140 may include a conventional ROM device or another type of static data storage that stores static information and instructions for the processor 120. The data storage 140 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 140 may store a set of instructions detailing a method that when executed by one or more processors cause the one or more processors to perform the method. The data storage 140 may also be a database or a database interface for storing a trace timeline.

The input device 150 may include one or more conventional mechanisms that permit a user to input information to the computing device 100, such as a keyboard, a mouse, a voice recognition device, a microphone, a headset, a gesture recognition device, a touch screen, etc. The output device 160 may include one or more conventional mechanisms that output information to the user, including a display 162, a printer, one or more speakers, a headset, or a medium, such as a memory, or a magnetic or optical disk and a corresponding disk drive. The communication interface 170 may include any transceiver-like mechanism that enables computing device 100 to communicate with other devices or networks. The communication interface 170 may include a network interface or a transceiver interface. The communication interface 170 may be a wireless, wired, or optical interface.

The computing device 100 may perform such functions in response to processor 120 executing sequences of instructions contained in a computer-readable medium, such as, for example, the memory 130, a magnetic disk, or an optical disk. Such instructions may be read into the memory 130 from another computer-readable medium, such as the data storage 140, or from a separate device via the communication interface 170.

FIG. 2 illustrates, in a block diagram, one embodiment of a scenario tree 200. A scenario tree 200 may be based on a trace timeline 202. A trace timeline 202 is a recording of a computer system activity taken to analyze the performance of that computer system activity. The system analyzer may receive a set of partition criteria from a user to analyze the trace timeline 202. The system analyzer may automatically partition one or more scenarios 204 from the trace timeline 202 based on the partition criteria on a scenario-aware basis. For example, the system analyzer may partition periods of active mode and connected standby mode out of a trace timeline 202 of a device state.

The system analyzer may then identify a scenario type for each scenario 204 and assign a sub-component of the system analyzer that specializes in that scenario type for analysis. The scenario specific sub-component may then automatically sub-partition a scenario 204 into a set of sub-scenarios 206, or sub-scenario set, to determine the cause of the scenario 204. In the above example, exiting connected standby mode may be caused by an activator holding a reference or a driver in the wrong state. A scenario 204 may have multiple sub-scenarios 206, which may overlap or not. The system analyzer may further identify a scenario type for each sub-scenario 206, and assign those sub-scenarios 206 to sub-components that specializes in those scenario types. These scenario specific sub-components may then sub-partition each sub-scenario 206 to discover the cause of that sub-scenario 206.

The system analyzer may iterate the sub-partitioning process for multiple logic levels 208, to create one or more scenario branches 210 for the scenario 204. The scenario branch 210 may have multiple branch nodes 212, each representing a next logic level sub-scenario 206. A branch node 212 references a scenario 204 or sub-scenario 206 in the scenario branch 210. The system analyzer may iterate the sub-partitioning process until an end node for each scenario branch 210 is reached. The end node may be a branch node 212 that may be irreducible to a sub-scenario. The end node may be a root cause 214. A root cause 214 is a basic activity that causes the scenario 204. A scenario 204 may have multiple possible root causes 214. The system analyzer may mark a branch node 212 as a third party component node 216 if the inner workings of that branch node 212 are opaque. A third party component node may be provided by an outside developer, having unknown inner workings.

In the above example, the activator holding the reference may be caused by a calendar program holding the reference, or a mail program holding the reference. The mail program may be holding the reference because of a server connection delay or an input/output related delay. The server connection delay or the input/output related delay may be the root cause 214 of the scenario 204 of exiting connected standby mode.

A branch node 212 in one scenario branch 210 may be a match 218 to a second branch node 212 in a second scenario branch 210. The branch nodes 212 may be marked as a match 218 to indicate that the same branch node 212 may be the cause of two different scenarios 204 or sub-scenarios 206. Further, a root cause 214 for one scenario branch 210 may be a match 218 to a second root cause 214 for a second scenario branch 210. The root causes 214 may be marked as a match 218 to indicate that the same root causes 214 may be the cause of two different scenarios 204 or sub-scenarios 206. A match 218 may exist between branch nodes 212 on different logic levels 208 or the same logic level 208.

A branch node 212 in one scenario branch 210 may have a node relationship 220 with a second branch node 212 in a second scenario branch 210. The node relationship 220 may indicate that the first branch node 212 is caused by a root cause 214 that matches the root cause 214 of the second branch node 212. A node relationship 220 may exist between branch nodes 212 on different logic levels 208 or the same logic level 208.

After the scenario tree 200 has been calculated, the system analyzer may display the results to the user. FIG. 3 illustrates, in a block diagram, one embodiment of a partitioned trace timeline display 300. The partitioned trace timeline display 300 may present the scenarios 204 as a nested list 302. A nested list 302 may list the partitioned scenarios 204 for the user. As the user selects a scenario 204, the nested list 302 may expand to show the sub-scenarios 206 sub-partitioned from that scenario 204. The user may continue expanding the list until each root cause 214 or third party component node 216 is displayed.

The partitioned trace timeline display 300 may have time map 304 that is matched to the nested list 302. The time map 304 may have a map timeline for each line in the nested list 302. The map timeline may illustrate when each branch node 212 occurs in the timeline. The map timeline may be color coded so that if two sub-scenarios 206 are compacted into the next higher logic level 208, the user may still see when each sub-scenario is occurring in that map timeline. An event in the map timeline may be time-scoped. Time-scoping is the expansion of detail on an event in a map timeline so that the user may clearly differentiate between events. Time-scoping may be useful when multiple events are occurring over a very short time period.

The partitioned trace timeline display 300 may have a detail panel 306. The detail panel may describe a branch node 212 selected by the user in greater detail. The detail panel 306 may reference specific lines of code that created the branch node 212, or give more exact timing data for that branch node 212.

FIG. 4 illustrates, in a flowchart, one embodiment of a method 400 for creating a trace timeline. The system analyzer may set test criteria for a test run of a computer system activity (Block 402). The system analyzer may execute the test run of the computer system activity (Block 404). The system analyzer may record a trace timeline 202 of the test run of the computer system activity (Block 406). The system analyzer may automatically analyze the trace timeline 202 of the computer system activity (Block 408).

FIG. 5 illustrates, in a flowchart, one embodiment of a method 500 for sub-partitioning the trace timeline. The system analyzer may set partition criteria for a scenario (Block 502). The system analyzer may automatically partition a scenario 204 of the trace timeline 202 on a scenario aware-basis, based on the partition criterion (Block 504). The system analyzer may identify a scenario type for the scenario 204 to assign the scenario 204 to a scenario specific sub-component for analysis (Block 506). The scenario specific sub-component of the system analyzer may analyze the scenario 204 for the purpose of sub-partitioning (Block 508). The scenario specific sub-component for the system analyzer may automatically sub-partition the scenario 204 into a sub-scenario set (Block 510). If the system analyzer determines that an end node of a scenario branch 210 has not been reached (Block 512), the system analyzer may identify a scenario type for a sub-scenario 206 of the sub-scenario set to assign the sub-scenario 206 to a scenario specific sub-component for further analysis and sub-partitioning (Block 506). If the system analyzer determines that an end node of a scenario branch has been reached (Block 512) and a third party component is reached (Block 514), the system analyzer may mark the end node as a third party component node 216 (Block 516). Otherwise, the system analyzer may mark an end node as a root cause 214 to a sub-scenario 206 of a sub-scenario set (Block 518). The system analyzer may match a branch node 212 of a scenario branch 210 to an ancillary branch node 212 of an ancillary scenario branch 210 (Block 520). The system analyzer may match a root cause 214 of a scenario branch 210 to an ancillary root cause 214 of an ancillary scenario branch 210 (Block 522). The system analyzer may denote a node relationship between a branch node 212 of a scenario branch 210 and an ancillary branch node 212 of an ancillary scenario branch 210 (Block 524).

FIG. 6 illustrates, in a flowchart, one embodiment of a method 600 for displaying a sub-partitioned trace timeline. The system analyzer may display a sub-partitioned trace timeline 202 to the user (Block 602). The system analyzer may present a nested list 302 representing a sub-partitioned trace timeline 202 (Block 604). The system analyzer may present a time map 304 representing a sub-partitioned trace timeline 202 (Block 606). The system analyzer may color code a branch node 212 in the time map 304 (Block 608). If the system analyzer receives an input from a user selecting a branch node 212 (Block 610), the system analyzer may time-scope the branch node 212 in the time map 304 (Block 612). The system analyzer may display a node detail of the branch node 212 in a detail panel 306 (Block 614).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
analyzing automatically a trace timeline of a computer system activity;
partitioning automatically a scenario of the trace timeline on a scenario-aware basis; and
sub-partitioning automatically the scenario into a sub-scenario set.

2. The method of claim 1, further comprising:
identifying a scenario type for the scenario to assign the scenario to a scenario specific sub-component for analysis.

3. The method of claim 1, further comprising:
determining an end node of a scenario branch has been reached.

4. The method of claim 1, further comprising:
marking an end node as a root cause to a sub-scenario of the sub-scenario set.

5. The method of claim 1, further comprising:
marking an end node as a third party component node if a third party component is reached.

6. The method of claim 1, further comprising:
matching a branch node of a scenario branch to an ancillary branch node of an ancillary scenario branch.

7. The method of claim 1, further comprising:
denoting a node relationship between a branch node of a scenario branch and an ancillary branch node of an ancillary scenario branch.

8. The method of claim 1, further comprising:
matching a root cause of a scenario branch to an ancillary root cause of an ancillary scenario branch.

9. The method of claim 1, further comprising:
recording the trace timeline of a test run of the computer system activity.

10. The method of claim 1, further comprising:
setting at least one partition criterion for the scenario.

11. The method of claim 1, further comprising:
displaying a sub-partitioned trace timeline to the user.

12. A tangible machine-readable medium having a set of instructions detailing a method stored thereon that when executed by one or more processors cause the one or more processors to perform the method, the method comprising:
partitioning automatically a scenario of the trace timeline on a scenario-aware basis;
sub-partitioning automatically the scenario into a sub-scenario set; and
displaying a sub-partitioned trace timeline to a user.

13. The tangible machine-readable medium of claim 12, wherein the method further comprises:
presenting a nested listing representing a sub-partitioned trace timeline.

14. The tangible machine-readable medium of claim 12, wherein the method further comprises:
presenting a time map representing a sub-partitioned trace timeline.

15. The tangible machine-readable medium of claim 14, wherein the method further comprises:
color coding a branch node in the time map.

16. The tangible machine-readable medium of claim 14, wherein the method further comprises:
time-scoping a branch node in the time map.

17. The tangible machine-readable medium of claim 12, wherein the method further comprises:
displaying a node detail of a branch node in a detail panel.

18. The tangible machine-readable medium of claim 12, wherein the method further comprises:
recording the trace timeline of a test run of the computer system activity.

19. A system analyzer, comprising:
a data storage that stores a trace timeline of a computer system activity;
a processor that partitions automatically a scenario of the trace timeline on a scenario-aware basis and sub-partitions automatically the scenario into a sub-scenario set; and
a display that presents a sub-partitioned trace timeline to a user.

20. The system analyzer of claim 19, wherein the processor marks an end node as a root cause to a sub-scenario of the sub-scenario set.
